(19) United States
(12) Patent Application Publication
(10) Pub. No.: US 2012/0285166 A1
(43) Pub. Date: Nov. 15, 2012

(54) HYBRID POWERTRAIN SYSTEM

(75) Inventor: Akram R. Zahdeh, Rochester Hills, MI (US)

(73) Assignee: GM GLOBAL TECHNOLOGY OPERATIONS LLC, Detroit, MI (US)

(21) Appl. No.: 13/105,061

(22) Filed: May 11, 2011

(51) Int. Cl. F02B 37/013; B60W 20/00; F02B 33/40

(52) U.S. Cl. 60/606; 60/605.1; 180/65.22

(57) ABSTRACT

A hybrid vehicle powertrain system comprises an internal combustion engine, an exhaust driven turbocharger in fluid communication with the internal combustion engine having a first exhaust gas turbine configured to receive exhaust gas from the internal combustion engine and to rotate a compressor configured to supply compressed air to the internal combustion engine for combustion therein, a second exhaust gas turbine in fluid communication with the first exhaust gas turbine of the exhaust driven turbocharger and configured to receive exhaust gas discharged from the first exhaust gas turbine to rotate a generator that is operably connected to an energy storage device and an electric drive motor configured to receive electrical energy from the energy storage device.

### FIELD OF THE INVENTION

Exemplary embodiments of the present invention relate to hybrid powertrain systems and, more particularly to hybrid powertrains having a plurality of internal combustion engine configurations.

### BACKGROUND

Increased concern over fuel economy and atmospheric emissions of greenhouse and other regulated exhaust emissions, caused by the combustion of hydrocarbon fuels in motor vehicles, has resulted in a concerted effort to develop more fuel efficient powertrain systems. One option has been the development of so-called hybrid vehicle powertrains that utilize a combination of electric drive powered by stored, onboard electrical energy, such as batteries, and an internal combustion engine. During operation of a vehicle utilizing a hybrid vehicle powertrain (i.e. a hybrid vehicle) a vehicle controller or controllers determines the optimal conditions for utilization of either electric drive or propulsion utilizing the internal combustion engine. As an example, in stop-and-go city driving or the driving typically experienced during rush hour freeway driving, the vehicle may be operated exclusively, or primarily, on battery power due to the lower loads required to propel the vehicle and to power various vehicle accessories. Upon depletion of energy reserves in the batteries or in driving situations requiring additional power, the internal combustion engine may be started and the vehicle may be propelled via electrical power supplemented by the internal combustion engine or by the internal combustion engine alone; depending in large part on the type of hybrid system (ex. series hybrid or parallel hybrid).

The internal combustion engine of choice has typically been a standard gasoline or diesel powered piston driven engine which, in hybrid applications, may be smaller than would typically be used in a non-hybrid application. Such piston driven internal combustion engines typically operate at about 30% efficiency with 70% of the energy utilized to operate the engine going to overcome frictional and other losses inherent in the design of the engines. As a result, during engine operation of the hybrid system efficiencies may not be optimal.

### SUMMARY OF THE INVENTION

In an exemplary embodiment of the invention, a hybrid vehicle powertrain system comprises an internal combustion engine, an exhaust driven turbocharger in fluid communication with the internal combustion engine having a first exhaust gas turbine configured to receive exhaust gas from the internal combustion engine and to rotate a compressor configured to supply compressed air to the internal combustion engine for combustion therein, a second exhaust gas turbine in fluid communication with the first exhaust gas turbine of the exhaust driven turbocharger and configured to receive exhaust gas discharged from the first exhaust gas turbine to rotate a generator that is operably connected to an energy storage device and an electric drive motor configured to receive electrical energy from the energy storage device.

In another exemplary embodiment of the invention, a hybrid vehicle powertrain system comprises an internal combustion engine, a turbine combustor, an exhaust driven turbocharger, in fluid communication with the internal combustion engine and the turbine combustor, having a first exhaust gas turbine configured to receive exhaust gas from the internal combustion engine and the turbine combustor and to rotate a compressor configured to supply compressed air to the internal combustion engine and the turbine combustor for combustion therein, a second exhaust gas turbine in fluid communication with the first exhaust gas turbine of the exhaust driven turbocharger and configured to receive exhaust gas discharged from the first exhaust gas turbine and to rotate a generator that is operably connected to an energy storage device and an electric drive motor configured to receive electrical energy from the energy storage device.

In yet another embodiment of the invention a method of operating a hybrid vehicle powertrain system having an internal combustion engine, a turbine combustor, an exhaust driven turbocharger, in fluid communication with the internal combustion engine and the turbine combustor, having a first exhaust gas turbine configured to receive exhaust gas from the internal combustion engine and the turbine combustor and to rotate a compressor configured to supply compressed air to the internal combustion engine and the turbine combustor for combustion therein, a second exhaust gas turbine in fluid communication with the first exhaust gas turbine of the exhaust driven turbocharger and configured to receive exhaust gas discharged from the first exhaust gas turbine and to rotate a generator that is operably connected to an energy storage device, an electric drive motor configured to receive electrical energy from the energy storage device comprises shutting off the internal combustion engine, delivering all of the compressed combustion air supplied by the compressor to the turbine combustor, delivering turbine exhaust gas to the first exhaust gas turbine, delivering exhaust gas expelled from the first exhaust gas turbine to the second exhaust gas turbine to rotate the generator and delivering electrical energy from the generator to the energy storage device, the electric drive motor, or a combination thereof.

The above features and advantages and other features and advantages of the invention are readily apparent from the following detailed description of the invention when taken in connection with the accompanying drawings.

### BRIEF DESCRIPTION OF THE DRAWINGS

Other objects, features, advantages and details appear, by way of example only, in the following detailed description of the embodiments, the detailed description referring to the drawings in which:

FIG. 1 is a schematic view of a hybrid powertrain system, embodying features of the invention, in a first mode of operation;

FIG. 2 is a schematic view of a hybrid powertrain system, embodying features of the invention, in a second mode of operation; and

FIG. 3 is a schematic view of a hybrid powertrain system, embodying features of the invention, in a third mode of operation.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features.

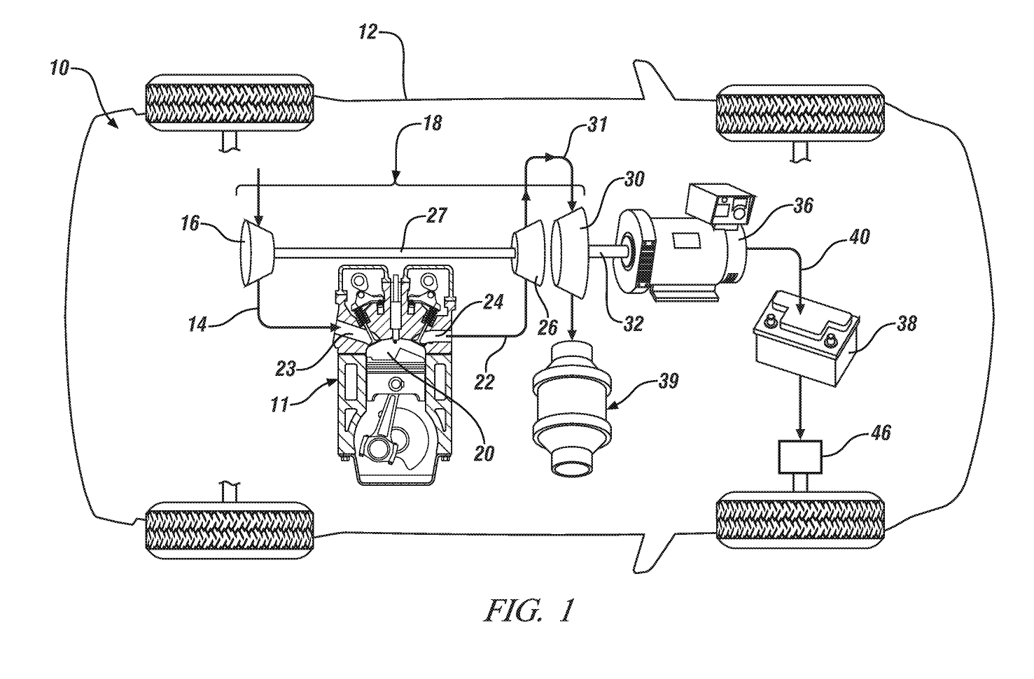

Referring to FIG. 1, an exemplary embodiment of the invention is directed to a hybrid vehicle powertrain system10, for efficiently propelling (i.e. operating) a hybrid vehicle 12. The hybrid vehicle powertrain system10 may comprise a parallel hybrid powertrain, FIG. 1, or a series hybrid powertrain (not shown) as is commonly known in the automotive art. An internal combustion engine 11 is in fluid communication with, and receives compressed combustion air 14 from, a compressor 16 of an exhaust driven turbocharger 18. The compressed combustion air 14 enters the internal combustion engine 11 through one or more valved combustion air intake ports 23 and is mixed with fuel in one or more combustion chambers 20 for combustion therein. Exhaust gas 22, produced through the combustion of the fuel and compressed combustion air 14, is exhausted through one or more valved exhaust ports 24 of the internal combustion engine 11 and is directed to a first exhaust gas turbine 26 of the exhaust gas driven turbocharger 18. The first exhaust gas turbine 26 is rotatably connected to the compressor 16 of the exhaust gas driven turbocharger 18 through first shaft 27 and, through the expenditure of waste exhaust gas energy from the exhaust gas 22 flowing therethrough, operates to rotate the compressor 16 to thereby produce the compressed combustion air 14 for supply to the internal combustion engine 11.

Referring again to FIG. 1, in an exemplary embodiment, the exhaust gas driven turbocharger 18 further comprises a second exhaust gas turbine 30 that is in fluid communication with and is configured to receive exhaust gas 31 that is discharged from the first exhaust gas turbine 26. In an exemplary embodiment, the second exhaust gas turbine 30 is rotatably mounted on a second shaft 32 that may be disposed coaxially with the first shaft 27 of the first exhaust gas turbine 26. The second exhaust gas turbine 30 is configured to rotate at a different speed than the first exhaust gas turbine 26. The second exhaust gas turbine 30, and associated second shaft 32, is rotatably connected to an electrical generator 36 that is operably connected to provide electrical power 40 to a battery or other energy storage device 38. The energy storage device 38 may be configured to operate an associated electric drive motor 46, in lieu of the internal combustion engine 11, to drive the hybrid vehicle 12 during selected modes of vehicle operation. The maximum rotational speed of the second exhaust gas turbine 30 is selected to match the rotational parameters and power output requirements of the generator 36. As the generator 36 is rotated by the second exhaust gas turbine 30, the exhaust gas energy expelled from the first exhaust gas turbine 26 is recovered and converted by the second exhaust gas turbine 30, and associated generator 36, into electrical energy 40 for delivery to the energy storage device 38. The maximum rotational speed of the second exhaust gas turbine 30 is selected to protect the generator 36 from damage due to over-speed rotation thereof and produce optimal electrical energy. As a result of the above described configuration, a full expansion and energy extraction of the exhaust gas 22 and 31 is achieved and utilized for operation of the hybrid vehicle 12. The exhaust gas 31 is subsequently delivered to an exhaust gas treatment system 39 for the oxidation, reduction or removal of regulated exhaust gas constituents prior to its release to the atmosphere.

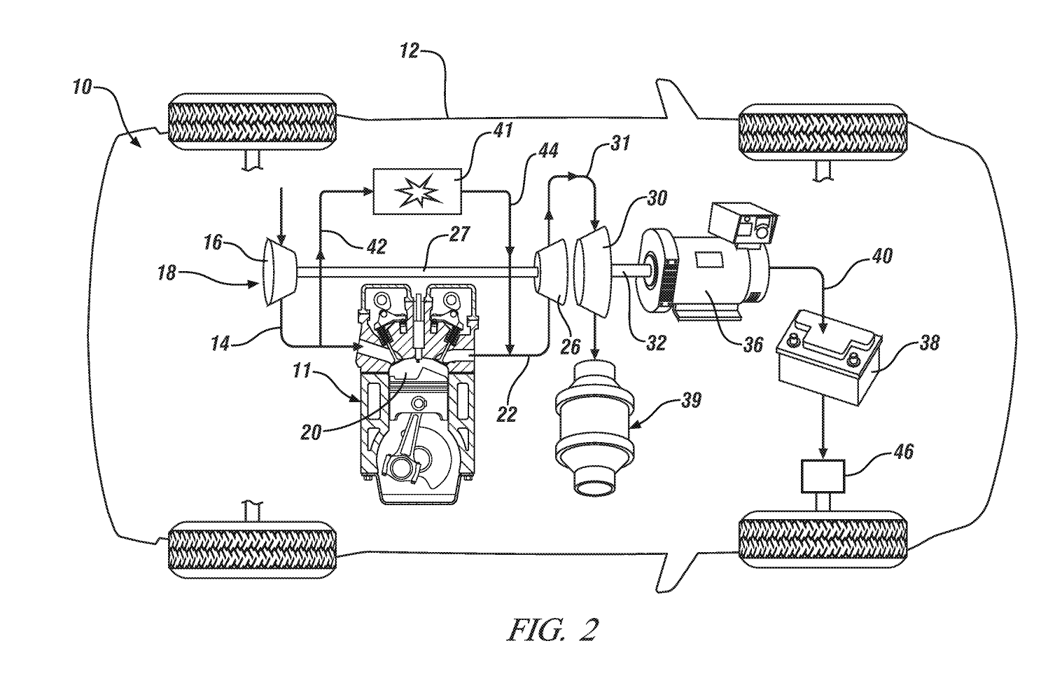

Referring to FIG. 2, in another exemplary embodiment, a combustor such as turbine combustor 41 is configured to receive a portion 42 of the compressed combustion air 14 supplied by the compressor 16 of the exhaust driven turbocharger 18. The turbine combustor 41 receives and combines the turbine portion 42 of the compressed combustion air 14 with fuel for combustion therein. Turbine combustor exhaust gas 44 is delivered to the first exhaust gas turbine 26 as an added component of the exhaust gas 22 discharged from the internal combustion engine 11. The addition of the turbine combustor exhaust gas 44 to the engine exhaust gas 22 increases the energy that may be extracted therefrom by the first exhaust gas turbine 26. The result is an increase in engine 11 performance through an increase in compressed combustion air 14 delivered by the compressor 16 during selected modes of operation, such as high performance operation, of the hybrid vehicle 12.

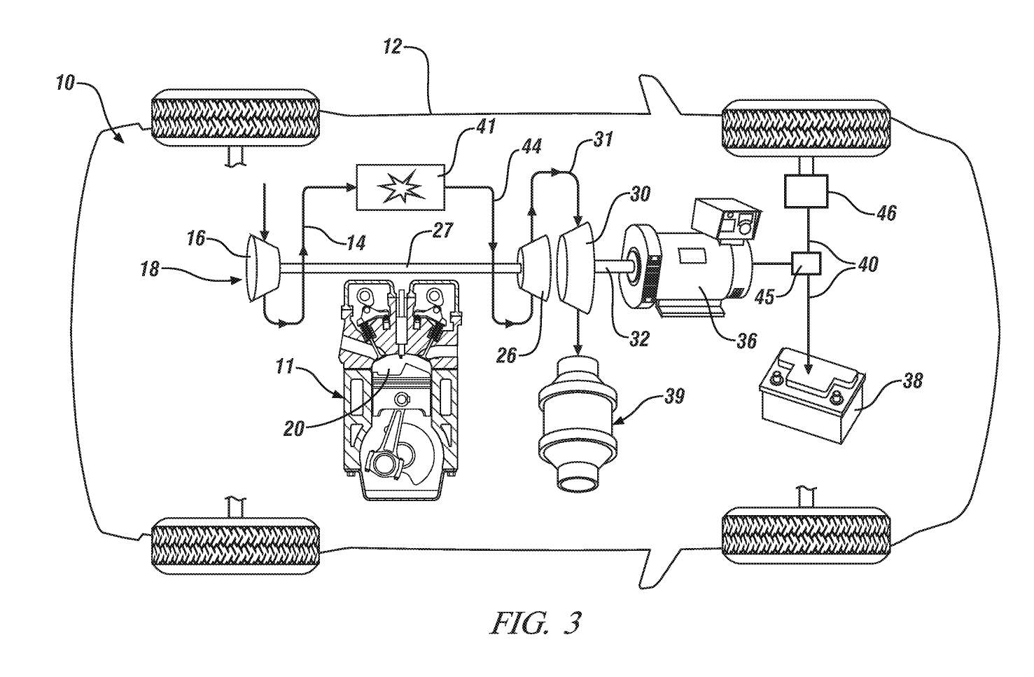

Referring now to FIG. 3, in an exemplary embodiment, during selected operating conditions of the hybrid vehicle 12 (ex. slow, stop-and-go driving in heavy traffic for instance), the internal combustion engine 11 may be shut off. In the operational mode illustrated, the turbine combustor 41 receives all of the compressed combustion air 14 supplied by the compressor 16 of the exhaust driven turbocharger 18. The turbine combustor 41 receives and combines the compressed combustion air 14 with fuel for combustion therein. Turbine combustor exhaust gas 44 is delivered to the first exhaust gas turbine 26 which, as described above, is rotatably connected to the compressor 16 of the exhaust gas driven turbocharger 18 through first shaft 27. Through the expenditure of waste exhaust gas energy from the exhaust gas flowing therethrough, the first exhaust gas turbine 26 operates to rotate the compressor 16 to thereby produce the compressed combustion air 14 for supply to the turbine combustor 40. The second exhaust gas turbine 30, and associated second shaft 32, rotates the generator 36 to create electrical power 40 for delivery to the energy storage device 38, for delivery to an electric drive motor 46 of the hybrid vehicle to thereby propel the vehicle without the assistance of the internal combustion engine 11. In an alternative mode of operation, the electrical power 40 may be delivered, such as through selectable switch 45, directly to the electric drive motor 46 of the hybrid vehicle 12 to thereby propel the vehicle without the assistance of the internal combustion engine 11. In another exemplary embodiment, selectable switch 45 may be used to deliver electrical energy 40 to both the energy storage device 38 and the electric drive motor 46 at the same time.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed as the best mode contemplated for carrying out this invention, but that the invention will include all embodiments falling within the scope of the present application.

What is claimed is:

1. A hybrid vehicle powertrain system comprising:
an internal combustion engine;
an exhaust driven turbocharger in fluid communication with the internal combustion engine having a first exhaust gas turbine, configured to receive exhaust gas from the internal combustion engine and to rotate a compressor, through a first shaft, configured to supply compressed air to the internal combustion engine for combustion therein;
a second exhaust gas turbine in fluid communication with the first exhaust gas turbine of the exhaust driven turbocharger and configured to receive the exhaust gas discharged from the first exhaust gas turbine and to rotate a generator that is operably connected to an energy storage device; and
an electric drive motor configured to receive electrical energy from the energy storage device, the internal combustion engine and electric drive motor comprising a hybrid vehicle powertrain system.

2. The hybrid powertrain system of claim 1, wherein the second exhaust gas turbine is rotatably mounted on a second shaft that is disposed coaxially with the first shaft.

3. The hybrid powertrain system of claim 1, wherein the second exhaust gas turbine is configured to rotate at a different speed than the first exhaust gas turbine.

4. The hybrid powertrain system of claim 3, wherein the size, and thus the rotational speed of the second exhaust gas turbine is selected to match the rotational parameters of the generator.

5. The hybrid powertrain system of claim 1, further comprising a turbine combustor in fluid communication with and configured to receive a portion of the compressed air supplied by the compressor of the exhaust driven turbocharger and to combine the portion of the compressed combustion air with fuel for combustion therein.

6. The hybrid powertrain system of claim 1, wherein the turbine combustor is in fluid communication with and is configured to deliver high pressure combustor exhaust gas to the first exhaust gas turbine.

7. A hybrid vehicle powertrain system comprising:
an internal combustion engine;
a turbine combustor;
an exhaust driven turbocharger, in fluid communication with the internal combustion engine and the turbine combustor, having a first exhaust gas turbine configured to receive exhaust gas from the internal combustion engine and the turbine combustor and to rotate a compressor configured to supply compressed air to the internal combustion engine and the turbine combustor for combustion therein;
a second exhaust gas turbine in fluid communication with the first exhaust gas turbine of the exhaust driven turbocharger and configured to receive the exhaust gas discharged from the first exhaust gas turbine and to rotate a generator that is operably connected to an energy storage device; and
an electric drive motor configured to receive electrical energy from the energy storage device, the internal combustion engine and electric drive motor comprising a hybrid vehicle powertrain system.

8. The hybrid vehicle powertrain system of claim 7, wherein the second exhaust gas turbine is rotatably mounted on a second shaft that is disposed coaxially with the first shaft.

9. The hybrid vehicle powertrain system of claim 7, wherein the second exhaust gas turbine is configured to rotate at a different speed than the first exhaust gas turbine.

10. The hybrid vehicle powertrain system of claim 9, wherein the size, and thus the rotational speed of the second exhaust gas turbine is selected to match the rotational parameters of the generator.

11. A method of operating a hybrid vehicle powertrain system having an internal combustion engine, a turbine combustor, an exhaust driven turbocharger in fluid communication with the internal combustion engine and the turbine combustor and having a first exhaust gas turbine configured to receive exhaust gas from the internal combustion engine and the turbine combustor to rotate a compressor configured to supply compressed air to the internal combustion engine and the turbine combustor for combustion therein, a second exhaust gas turbine in fluid communication with the first exhaust gas turbine of the exhaust driven turbocharger and configured to receive exhaust gas discharged from the first exhaust gas turbine and to rotate a generator that is operably connected to an energy storage device and an electric drive motor configured to receive electrical energy from the energy storage device comprising:
shutting off the internal combustion engine;
delivering all of the compressed combustion air supplied by the compressor to the turbine combustor;
delivering turbine exhaust gas to the first exhaust gas turbine;
delivering exhaust gas expelled from the first exhaust gas turbine to the second exhaust gas turbine to rotate the generator; and
delivering electrical energy from the generator to the energy storage device, the electric drive motor, or a combination thereof.

12. The method of operating a hybrid vehicle powertrain system of claim 11, further comprising:
starting the internal combustion engine;
delivering compressed combustion air supplied by the compressor to the internal combustion engine and the turbine combustor;
delivering exhaust gas from the internal combustion engine and the turbine combustor to the first exhaust gas turbine;
delivering exhaust gas expelled from the first exhaust gas turbine to the second exhaust gas turbine to rotate the generator; and
delivering electrical energy from the generator to the energy storage device, the electric drive motor, or a combination thereof.
